(19) United States
(12) Patent Application Publication
(10) Pub. No.: US 2017/0190068 A1
(43) Pub. Date: Jul. 6, 2017

(54) CUTTING DEVICE

(71) Applicant: GRADE GROUP AS, SKI (NO)

(72) Inventor: Tord SJÖDÈN, Järfälla (SE)

(73) Assignee: GRADE GROUP AS, SKI (NO)

(21) Appl. No.: 15/324,244

(22) PCT Filed: Jun. 30, 2015
(86) PCT No.: PCT/EP2015/064810

§ 371 Date: Jan. 5, 2017

(30) Foreign Application Priority Data
Jul. 8, 2014 (SE) 1450875-8

(51) Int. Cl. B26D 1/553; B26F 3/12; B26D 5/10; B26D 3/00; B26D 5/00

(52) U.S. Cl. CPC B26D 1/553; B26D 3/006; B26D 5/005; B26D 5/10; B26F 3/12

(57) ABSTRACT

A cutting device for cutting a material includes: a frame structure arranged to be pivoted around a pivot axis, wherein the frame structure includes at least two essentially parallelly arranged frame portions arranged at a distance (d) from each other along a first axis (x), wherein a cutting wire is arranged between the frame portions and connected to the respective frame portions, wherein the material is cut and formed by the cutting wire during a pivoting relative movement between the frame structure and the material around a pivot axis (p).

### TECHNICAL FIELD

The present invention relates generally to a cutting device for cutting material.

### BACKGROUND ART

In prior art it is known to form and cut foam material using a plurality of parallel arranged electric heating wires. Prior art document U.S. Pat. No. 4,574,677 discloses a cutting apparatus comprising a support frame swingably arranged around a horizontal axis to adjust slab cut thickness. Another known solution is described in utility model CN201950705 wherein a rotation of a semi-circular heating wire is provided for processing blind and through holes in a foam material.

A drawback of the known art is the limitation in forming the material to various and preferred complex shapes for specific applications.

### SUMMARY OF INVENTION

An object of the present invention is to alleviate some of the disadvantages of the prior art and to provide a cutting device which enables the forming of a material to complex shapes.

Another object of the present invention is to provide a cutting device which enables the forming of the material in a fast and cost-efficient manner.

According to one embodiment of the invention, a cutting device for cutting a material is provided, comprising

a frame structure comprising at least two essentially parallelly arranged frame portions arranged at a distance from each other along a first axis,
a cutting wire extending between the frame portions and connected to the respective frame portions
wherein the material is cut and formed by the cutting wire during a pivoting relative movement between the frame structure and the material around a pivot axis.

According to one embodiment said pivot axis is running through a pivot point arranged at any point along said first axis arranged at a distance from a point associated with the material or frame structure.

Arranging a pivot point and a related imaginary pivot axis along an elongated axis extending through both frame portions but located outside the distance between the frame portions, enable manufacturing of other shapes than when the pivot axis is for example extending through one of the frame portions.

According to one first embodiment said frame structure is arranged to be pivoted around a pivot axis.

According to one embodiment said frame structure is arranged to be moved in all directions in space.

Thus, it may be arranged to be moved in at least a direction essentially perpendicular and/or essentially parallel to the extension direction of the pivot axis. Being able to move the frame structure in a translational movement in relation to the material make it possible to create even more complex 3D shapes.

According to one second embodiment, said material is arranged to be pivoted around a pivot axis.

According to one embodiment, the pivot axis is arranged to extend through one of the frame portions.

According to one embodiment, said frame structure is arranged to be locked in all directions in space.

According to one embodiment, said material is arranged to be moved in all directions in space.

Thus, it may be arranged to be moved at least in a direction essentially perpendicular and/or essentially parallel to the extension direction of the pivot axis. Being able to move the material in a translational movement in relation to the frame structure make it possible to create even more complex 3D shapes.

According to one embodiment, said material is arranged on and attached to a transporting device which is arranged to be pivoted around a pivot axis.

According to one embodiment, said material is arranged to be locked in all directions in space.

According to one embodiment, the cutting wire extends between the frame portions with an angle α to a to a direction parallel to the first axis x of the frame structure.

According to one embodiment, the cutting wire extends at least two times between the frame portions or comprises at least two cutting wires extending between the frame portions.

According to another embodiment, the cutting wire comprises at least two cutting wires extending between the frame portions.

According to one embodiment, the cutting wire or cutting wires extend between the frame portions according to a recurrent pattern, comprising at least a first extension portion between the frame portions which is perpendicular to the pivot axis and at least a second extension portion which extends between the frame portions with an angle α to a direction perpendicular to the pivot axis of the frame structure.

According to one embodiment, the cutting wire is one of: an electric heating wire, a rotating wire or a reciprocating wire.

According to one embodiment, at least one driving device is arranged to pivot the frame structure in relation to the material and/or the material in relation to the frame structure.

According to one embodiment, at least one driving device is arranged to move said frame structure and/or said material in a direction essentially perpendicular and/or essentially parallel to the extension direction of the pivot axis and/or in any direction in space.

According to one embodiment, the distance d between the frame portions is in the range of 50 mm to 3000 mm, preferably 2000 mm.

According to one embodiment, the angle α is in the range of 0,1-5°, preferably in the range 0,1-3°.

According to one embodiment, the cutting wire extends essentially in a straight line between the frame portions.

According to one embodiment, the cutting wire or cutting wires is/are connected to the frame portions at connection points wherein the connection points are adjustable along the frame portions to control the angle α.

According to one embodiment, the cutting device is arranged to cut and form material in plate form, wherein a plurality of similarly and differently formed plates together form a surface covering system.

The invention may according to one embodiment be described as a cutting device for cutting a material, comprising:

a frame structure comprising at least two essentially parallelly arranged frame portions arranged at a distance from each other along a first axis,
a cutting wire extending between the frame portions and connected to the respective frame portions. The invention is characterized in that it further comprises
means for creating a pivoting relative movement between the frame structure and the material so that the material is cut and formed by the cutting wire.

According to one embodiment, said means for creating a pivoting relative movement is a driving device arranged to pivot the frame structure in relation to the material.

According to another embodiment, means for creating a pivoting relative movement is a driving device arranged to pivot the material in relation to the frame structure.

### BRIEF DESCRIPTION OF DRAWINGS

The invention is now described, by way of example, with reference to the accompanying drawings, in which:

FIG. 1 shows a perspective view of a cutting device for cutting material according to the invention.

FIG. 2a-FIG. 2c show a cutting device according to FIG. 1, in a first position in relation to a material.

FIG. 3a-3c show a cutting device according to FIG. 1, in a second position in relation to a material.

FIG. 4a-4c show positions a cutting device according to FIG. 1, in a third position in relation to a material.

FIG. 5a-5c show positions a cutting device according to FIG. 1, in a fourth position in relation to a material.

FIG. 6 shows a surface covering system comprising a plurality of plates formed by a cutting device according to FIG. 1.

FIGS. 7 and 8 shows a cutting device according to a second embodiment of the invention producing different plates according to the surface covering system of FIG. 6.

FIGS. 9a and 9b show an arrangement for cutting material using a cutting device according to the second embodiment of the invention.

### DESCRIPTION OF EMBODIMENTS

In the following, a detailed description of the invention will be given. In the drawing figures, like reference numerals designate identical or corresponding elements throughout the several figures. It will be appreciated that these figures are for illustration only and are not in any way restricting the scope of the invention.

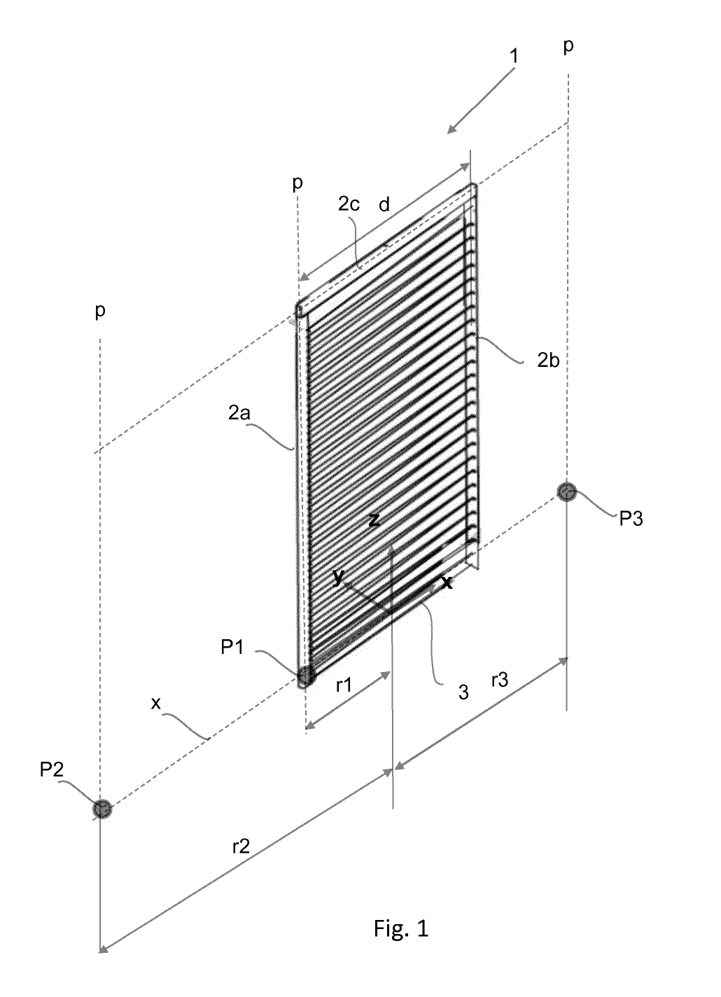

FIG. 1 shows a perspective view of a cutting device 1 for cutting material 4 (not shown in FIG. 1) according to the invention. The cutting device 1 comprises means for creating a pivoting relative movement between a frame structure 2 and the material so that the material is cut and formed by a cutting wire 3 arranged between a first and second frame portion 2a, 2b of the frame structure 2. Thus, the material 4 is cut and formed by the cutting wire 3 during a pivoting relative movement between the frame structure 2 and the material 4 around an imaginary pivot axis p.

The first and second frame portions 2a, 2b are arranged at a distance d from each other along along a first axis x. A coordinate system is provided comprising axis x, y, z defined in relation to the cutting device 1 of FIG. 1. The z-axis is in this embodiment arranged to extend through a point located between the first and second frame portion 2a, 2b, at a distance d/2 from the first frame portion 2a, and the first axis x coincide with the x-axis of the coordinate system. The pivot axis p may be placed at any point P (P1-P3) along first axis x, for example with a distance r (r1, r2 or r3) from the origin of the coordinate system.

According to a first embodiment, the cutting device 1 comprises a frame structure 2 arranged to be pivoted around a pivot axis p and said material 4 is arranged to be locked in all directions relation to the coordinate system. According to one embodiment, the pivot axis p is arranged to extend through one of the frame portions 2a, 2b. According to one embodiment, the frame structure 2 is pivotally suspended via a shaft (not shown) connected to a driving device (not shown) arranged to rotate the shaft.

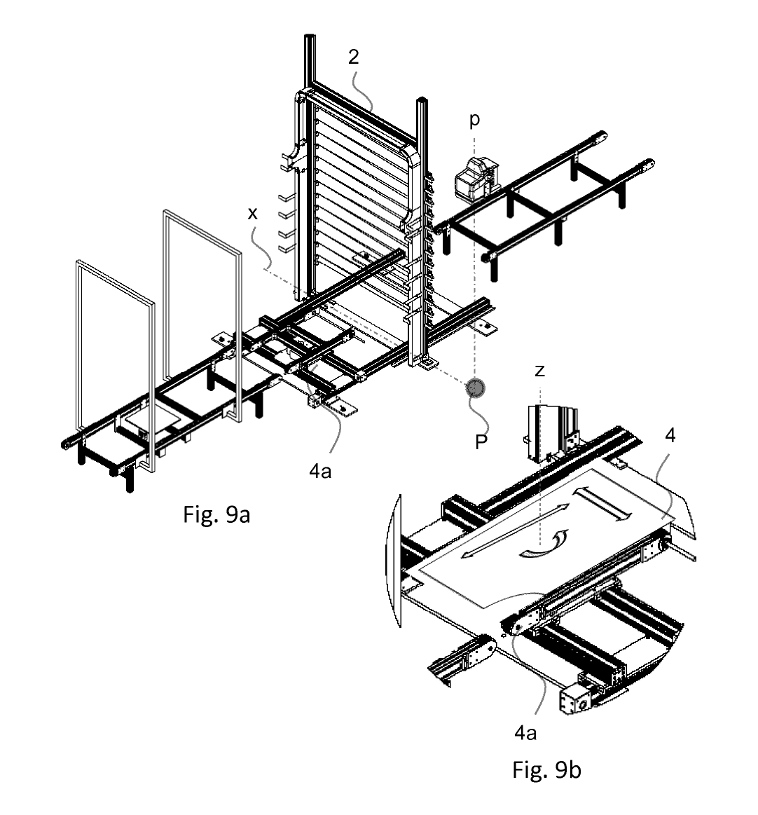

According to a second embodiment, further shown for example in FIGS. 9a and 9b, said material 4 is arranged to be pivoted around the pivot axis p and said frame structure 2 is arranged to be locked in all directions in space.

The frame structure 2 and/or the material 4 may further be arranged to be moved in any direction in space. This may be achieved by connecting the cutting device or material to a swing arm or robot arm according to one embodiment. This may further be achieved by suspending the cutting device 1 or the material 4 in an axle arranged to move in a first direction along a beam, wherein the beam itself may be movable in a second direction perpendicular to the first direction, functioning as a traverse. The beam may further be movable in a third, vertical direction perpendicular to the first and second directions. The controlling of the linear movement and thereby positioning of the frame structure/cutting device 1, as well as its rotation, may be carried out either by the aid of CNC (Computerized Numerical Control) or by manual control. Thus, the cutting device 1 and/or the material 4 is arranged to carry out a translation movement in space. This translational movement in any direction in space is necessary in order to enable rotation of the frame structure 2 or the material 4 around a pivot axis p arranged at a point along the first axis x which is not located between the first and second frame portions 2a, 2b, thus along the distance d.

The two frame portions 2a, 2b are essentially parallelly arranged at the distance d and may in one embodiment be connected by at least one connecting portion 2c. According to one embodiment, the frame portions 2a, 2b are arranged essentially vertically. According to one embodiment, the frame portions 2a, 2b have an elongated shape and have a length l in the range of 50 mm<length l<4000 mm. According to one embodiment, the frame portions 2a, 2b, and connection portion 2c are made of Aluminum or steel. According to one embodiment, the connecting portion 2c extends in an essentially horizontal direction between the frame portions 2a, 2b, thus forming an essentially U-shaped frame structure 2. According to one embodiment, the connecting portion 2c is arranged at an end portion of the respective frame portions 2a, 2b, wherein the distance between the frame portions 2a, 2b is open in one end and closed in the other end. According to one embodiment, the lowermost end when the frame structure 2 is arranged in the cutting device 1 is open, whereas the connecting portion 2c is arranged to close the uppermost distance between the frame portions 2a, 2b. According to one embodiment, the distance d between the frame portions 2a, 2b is in the range of 50 mm<distance d<3000 mm. According to one embodiment, the distance d is 2000 mm.

The cutting wire 3 is arranged between the frame portions 2a, 2b, and thus extends there between, and is further connected to the respective frame portions 2a, 2b. According to one embodiment, the cutting wire 3 may be arranged as a single wire 3, i.e. extending a plurality of times between the frame portions 2a, 2b in a back and forth manner. According to one embodiment, the cutting wire 3 extends between the frame portions 2a, 2b in recurrent pattern. According to one embodiment, a plurality of cutting wires 3 extending between the frame portions 2a, 2b, respectively, may be used as well. According to one embodiment, the cutting wire 3 extends in a straight line between the frame portions 2a, 2b long an imaginary x-axis. According to one embodiment, the cutting wire 3 is an electric heating wire. According to one embodiment, the cutting wire 3 is a rotating wire arranged to rotate around its own axis to provide an improved cutting ability, which is useful or even necessary to cut through certain material, e.g. EPS. According to one embodiment, the cutting wire 3 is arranged to be translated in in its axial direction for an enhanced cutting ability, thus acting as a saw. According to one embodiment, the cutting wire 3 is a resistance heating wire made of steel or metal suitable alloys such as e.g. Kanthal, Nichrome, Cupronickel etc.

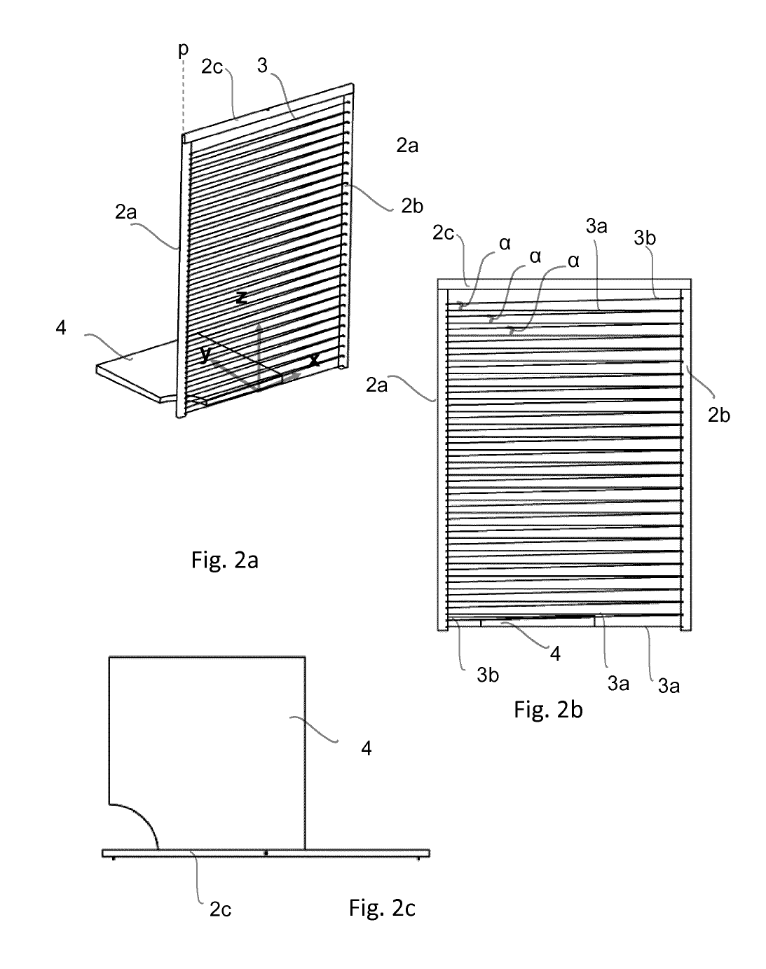

The cutting device 1 of FIG. 1 is adapted to form a resulting material 4 seen in FIG. 2a-2c, 3a-3c, 4a-4c, 5a-5c to complex shapes. The material 4 may be made from e.g. polystyrene of the EPS or the XPS type or polyamide plastics (PA), polypropene (PP) or polyurethane (PUR). According to one embodiment, the material 4 is glass foam or similar foam material. According to one embodiment, the material 4 is Rockwool.

FIG. 2a shows a cutting device 1 according to FIG. 1 in a first position in relation to an exemplary resulting cut-out and formed piece of a material 4 from the pivoting of the cutting device 1 or the pivoting of the material 4. According to one embodiment the material 4 has a cut-out portion 4a through which the pivot axis p may extend. In this embodiment, the pivot axis p coincide with the first frame portion 2a. The cut-out portion may have the shape of a circular segment. A coordinate system is provided comprising axis x, y, z defined in relation to the cutting device 1 of FIG. 1.

FIG. 2b shows the cutting device 1 and material 4 of FIG. 2a in a y-direction. In FIG. 2b the cutting wire 3 is arranged between the frame portions 2a, 2b and extends there between with an angle α to a direction perpendicular to the pivot axis p of the frame structure 2, i.e. at least in one embodiment being in relation to the horizontally arranged connecting portion 2c. According to one embodiment, the angle α is in the range of 0,1<α<5°. The inclination is a positive angle in the x-z coordinate system, thus leaning upwards from the first frame portion 2ato the second frame portion 2b.

According to one embodiment, the cutting wire 3 is arranged in a back-and-forth manner a plurality of times between the frame portions. According to one embodiment, the cutting wire 3 is arranged in a back-and-forth manner a plurality of times between the frame portions in a recurring manner, i.e. wherein the cutting wire extends between the frame portions 2a, 2b with certain angles an arbitrary number of time to create a defined set or series or pattern. This series/pattern is then repeated in a recurring manner an arbitrary number of times. This recurring pattern allows for a highly efficient cutting device 1 which enables the cutting of a plurality of similar cut-outs of the material in one and the same pivoting movement of the cutting device 1. Thereby, faster and cost-efficient solution is provided.

According to one embodiment, shown in FIGS. 2a-2c, 3a-3c, 4a-4c, 5a-5c, the cutting wire 3 comprises a first and a second extension portion 3a, 3b. Said first extension portion 3a extends essentially horizontally, between the frame portions 2a, 2b from frame portion 2b to frame portion 2a at a first connection point at frame portion 2b to a second connection point at frame portion 2a. Thereafter the second extension portion 3b is connected at a third connection point at a certain distance from the second connection point in the z-direction of frame portion 2a. This distance may be arbitrary, however, according to one embodiment, the distance is 50 mm. According to one embodiment, the second extension portion 3b has an angle α in relation to the first extension portion 3a which is 1-2° and connects at frame portion 2b at a fourth connection point. The distance between the first and the fourth connection points of frame portion 2b may be arbitrary. According to one embodiment, the fourth connection point has a distance from the first connection point in a z-direction which is 6 mm.

According to one embodiment, the cutting wire 3 is controllable by a control device. This comprises either or both controlling the rotations speed as well as the pattern series of the cutting wire 3 between the frame portions 2a, 2b. According to one embodiment, the location of the connection points of the cutting wire in the frame portions 2a, 2b are controllable by a control device, thereby controlling the pattern of the cutting wire 3. FIG. 2c shows the cutting device in a negative z-direction.

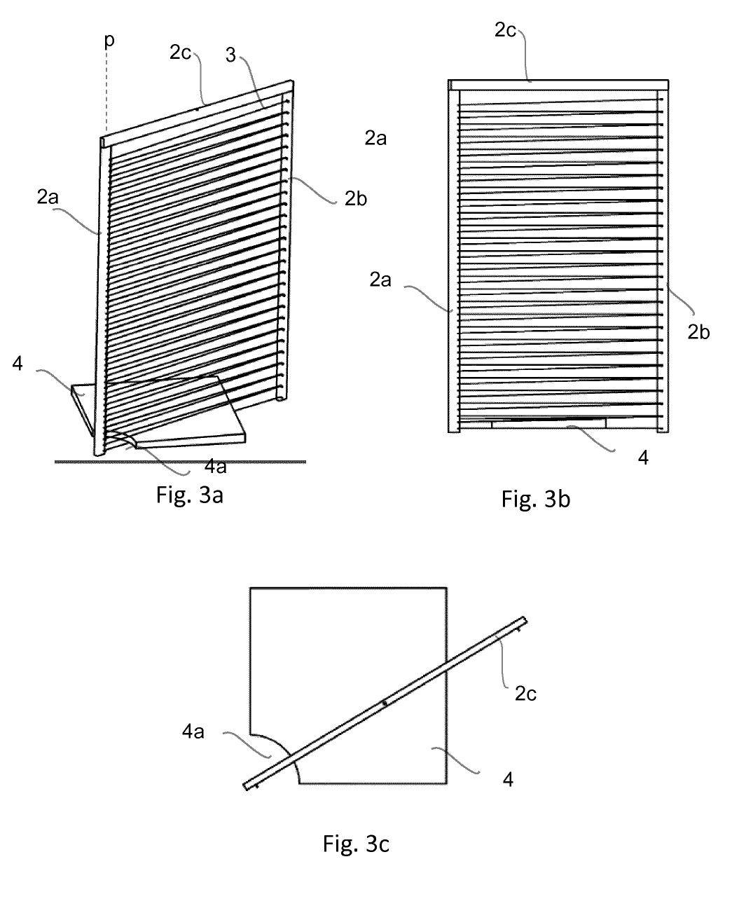

FIG. 3a-FIG. 3c shows a cutting device according to FIG. 1, in a second position in relation to an exemplary resulting formed/cut material 4. The frame portion 2 has pivoted ca 30° from the starting position of FIG. 2a-2c. FIG. 3b shows the cutting device 1 and material 4 of FIG. 3a in a y-direction. FIG. 3c shows the cutting device 1 and material 4 of FIG. 3a in negative z-direction.

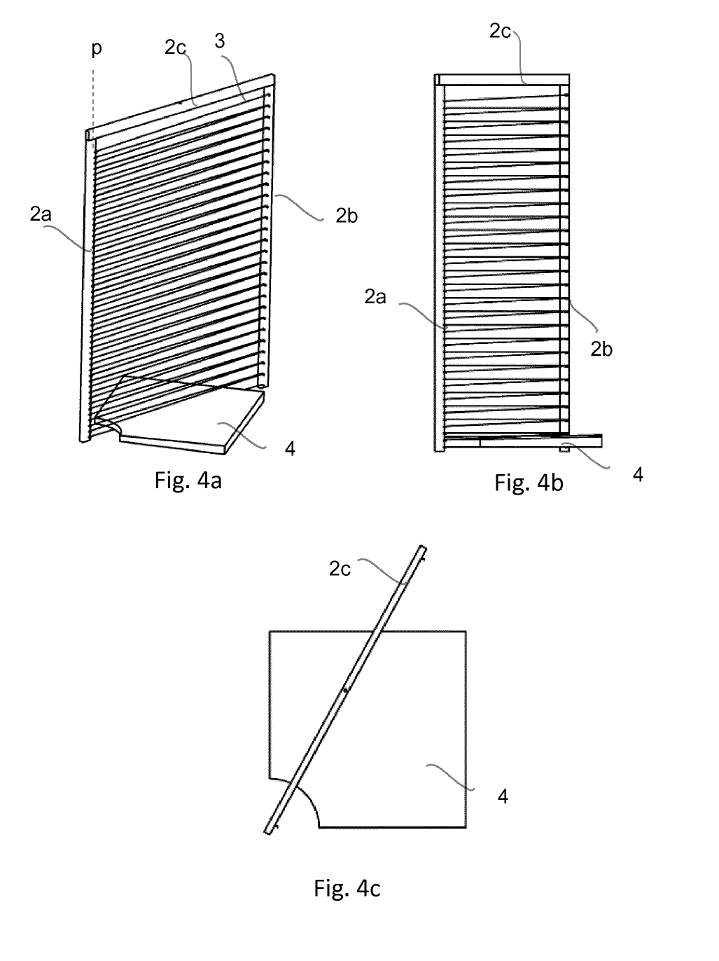

FIG. 4a-4c shows a cutting device according to FIG. 1, in a second position in relation to an exemplary resulting formed/cut material 4. The frame portion 2 has pivoted ca 60° from the starting position of FIG. 3a-3c. FIG. 4b shows the cutting device 1 and material 4 of FIG. 4a in a y-direction. FIG. 4c shows the cutting device 1 and material 4 of FIG. 4a in negative z-direction.

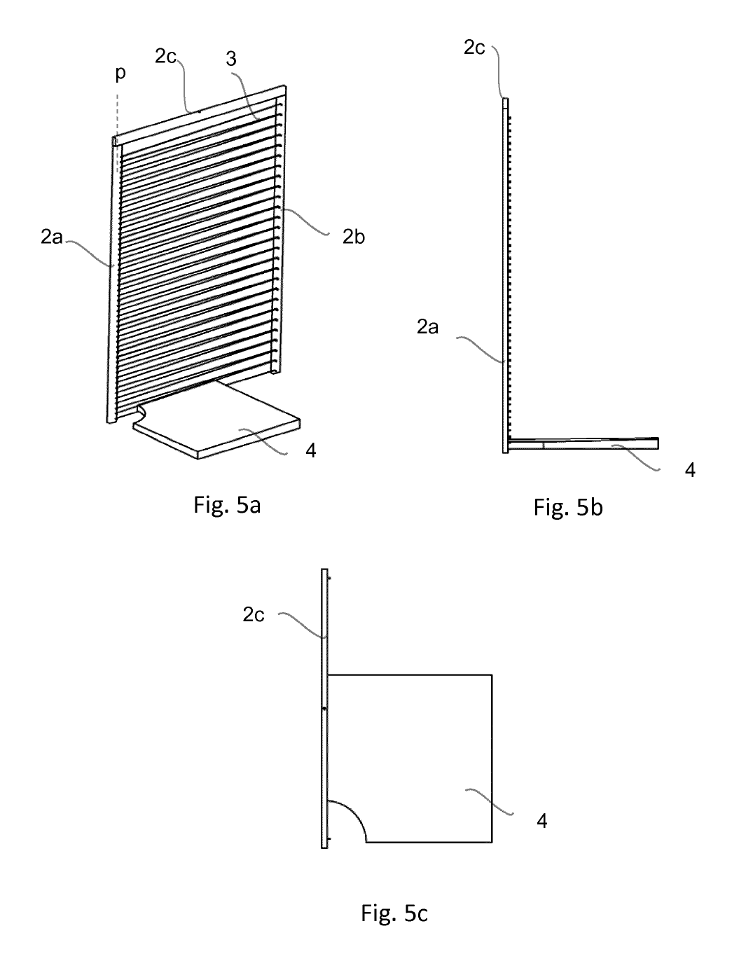

FIG. 5a-5c shows a cutting device according to FIG. 1, in a second position in relation to an exemplary resulting formed/cut material 4. The frame portion 2 has pivoted ca 90° from the starting position of FIG. 3a-3c. FIG. 4b shows the cutting device 1 and material 4 of FIG. 4a in a y-direction. FIG. 4c shows the cutting device 1 and material 4 of FIG. 4a in negative z-direction.

The cutting device 1 of FIG. 2a-2c, 3a-3c, 4a-4c, 5a-5c is adapted to cut the material 4 to complex shapes comprising conical shapes or part of cones as well as virtual cones or part of a virtual cone formed as a cavity in the material 4. Conical shapes are produced when the pivot axis is located somewhere along the imaginary x-axis at a distance, for example r3 shown in FIG. 1, from the origin of the coordinate system further away or equal to half the distance d between the frame portions 2a, 2b. A complete cone is produced when the pivot axis p is running through the second frame portion 2b. Virtual cones are produced when the pivot axis is running through the first frame portion 2a, or somewhere along the imaginary negative x-axis, for example at a distance r1 or r2 shown in FIG. 1.

Thus in FIGS. 2a-2c, 3a-3c, 4a-4c, 5a-5c, it has been shown one resulting shape of a material 4 from the pivoting and forming of the cutting device 1. The material 4 had initially an essentially rectangular shape in the x-y plane and extended preferably essentially in the z-direction at a length corresponding to the length of the frame portions 2a, 2b. As a result from the pivoting of the frame structure 2/cutting device 1 or material 4, a substantially flat lower surface, formed by the horizontal cutting wires 3a, and an upper surface with a first circular decline towards the pivot axis p having a radial slope a defined by the angle α of the cutting wire 3b in relation to cutting wire 3a from every point of the upper surface, is created. Thereby, the decline creates a cavity in the plate/material 4 which has the shape of at least a part of a blunt virtual cone with the apex of the cone directed towards the pivot axis p and a circular decline towards the pivot point defined by the angle α (pivot point may for example be P1 or P2 shown in FIG. 1). According to one embodiment, the cutting device 1 may be employed to instead form a real cone in a similar manner with the slope of the cone with a circular incline towards the pivot point P defined by the angle α (pivot point may for example be P3 shown in FIG. 1). According to one embodiment, the cutting device 1 may thereby be used to produce a surface covering system, such as for instance floors or roofs known through WO2013/172775 A1 by the applicant, wherein a plurality of plates of material 4 is arranged to form a floor or roof systems, in an efficient manner, both in terms of time and cost.

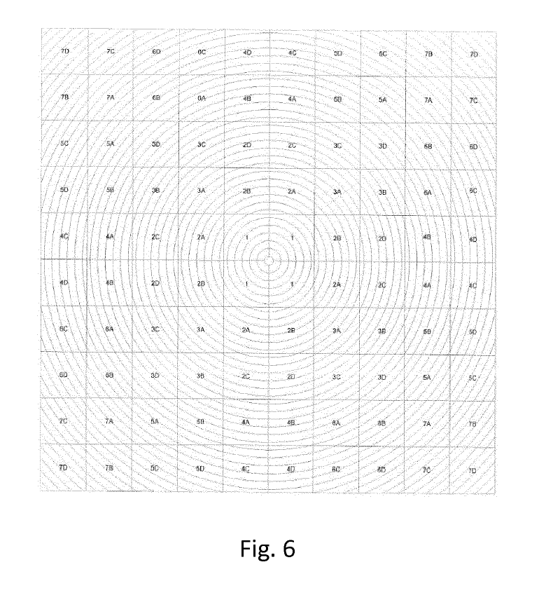

FIG. 6 discloses an exemplary surface covering system for e.g. a floor or a roof comprising plates that may be manufactured using the cutting device 1. According to one embodiment, the plates are numbered between 1-7, subdivided into A-D plates depending on their position in the surface covering system, which comprises a center point or a drainage point where water is arranged to exit the floor covering system. Like reference numerals designate identical or similar plates. As noted, plate 1 correspond to the hitherto described formed material 4, i.e. wherein a maximum 90° rotation of the cutting device 1 or material 4 without any required translation of the cutting device 1 forms this plate of the surface covering system. Other plates, for instance plates 2-7, requires a rotation of the cutting device 1/frame structure 2 or material 4 which is less than 90°, however, since the entire plate/material 4 needs to be formed, this requires a combination of a translation movement and a rotation movement of the cutting device 1/frame structure 2 around an imaginary pivot axis p arranged at a location different from the location when producing plate 1.

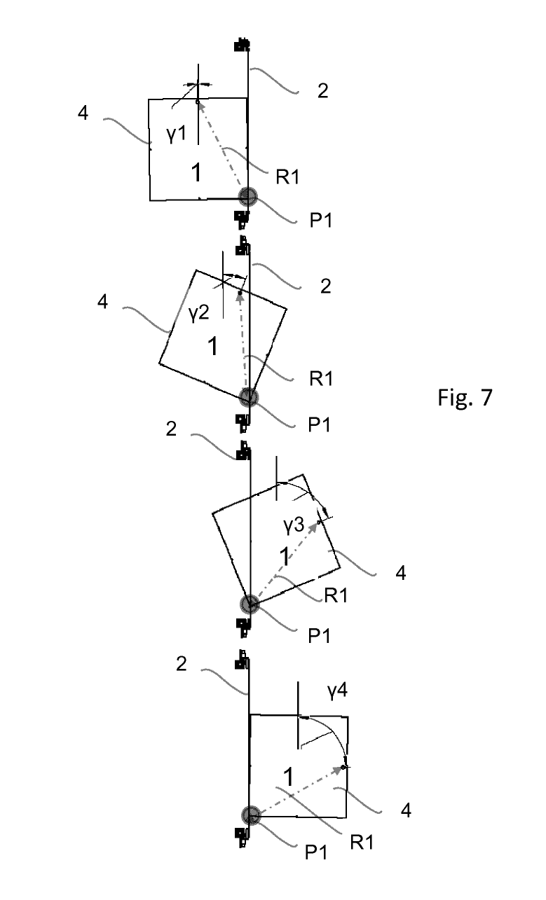

FIGS. 7, 8 and 9 disclose a second embodiment of the invention where the material 4 is rotating around the pivot point P1, P2 and pivot axis p1, p2 (not shown) and the cutting device 2 is held stationary, thus locked in all directions in space. The FIGS. 7-9 disclose embodiments adapted to form the material into plates according to the exemplary surface covering system shown in FIG. 6.

FIG. 7 disclose an embodiment where plate 1, as described in FIG. 6, is cut. This plate of the surface covering system is formed with a maximum 90° rotation of the material 4 without any required translation of the material 4 or cutting device 1. Thus, the material 4 cut by this arrangement may be compared to the material cut by the arrangement shown in FIGS. 2-5. However, in this embodiment the cutting device 2 is held stationary and the material 4 rotates around a first pivot point P1. Said pivot point P1 is arranged at a distance R1 from a material point, for example a point located near an edge of the material, associated with the material 4. An angle γ is defined as the angle between said point and the first axis x of the cutting device 2 when the material 4 rotates around its centre point. The material 4 is shown rotated from a first position where the edges of the material is parallel to the cutting device at an angle γ1≈0° to a final position where the angle γ4≈90°. Further, γ2≈25° and γ3≈70°.

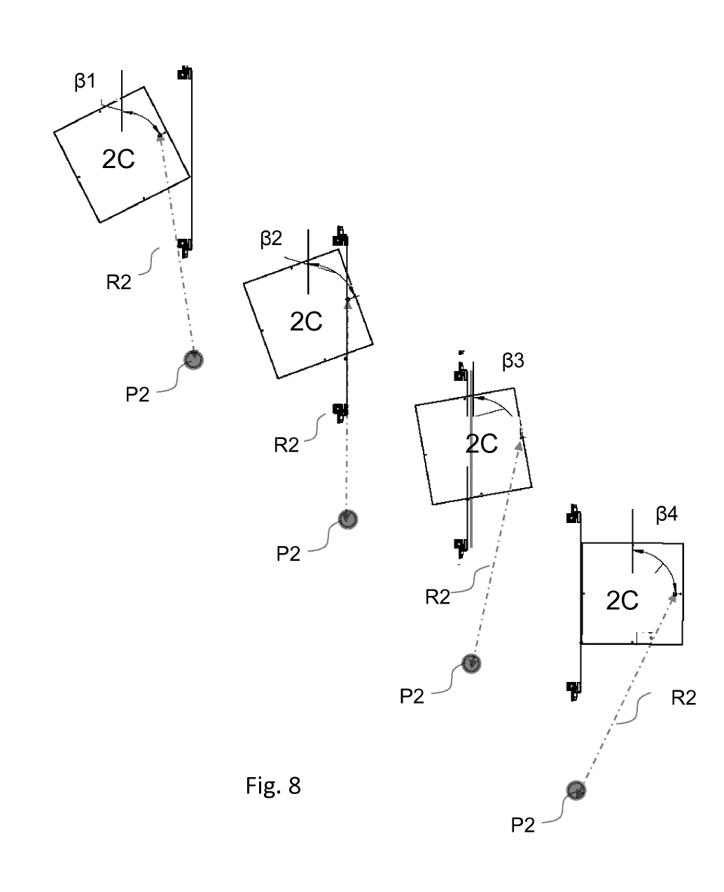

FIG. 8 disclose an embodiment where plate 2C, as described in FIG. 6, is cut. This plate require a rotation of the material which is less than 90°. Thus the production of this plate requires a combination of a translation movement and a rotation movement of the material 4 around an imaginary pivot axis p arranged at a location different from the location when producing plate 1. Therefore, the pivot point P2 is arranged at a distance R2 from the material point, where R2>R1. An angle β is defined as the angle between said point and the first axis x of the cutting device 2 when the material 4 rotates around its centre point. The material 4 is shown rotated from a first position where the edges of the material is rotated in relation to the cutting device so that the angle β1≈60° to a final position where the angle β4≈90°. Further, β2≈70° and β3≈80°.

According to one embodiment, the cutting device 1 is arranged to rotate 360° around the pivot axis p and thus form material 4 into an entire blunt virtual cone or real cone. Thus, according to one embodiment, the material 4 may have a surface area seen in the z-direction which is four times the area of FIGS. 2a-2c, 3a-3c, 4a-4c, 5a-5c. According to one embodiment, the process of cutting such material 4 may be initiated by a relative axial movement of the cutting device 1 and the material 4 in the z-direction wherein the cutting wire/s cuts a slot or makes an incision in the material 4 along its extension in the z-direction. Thereafter, the rotation/pivoting of the cutting device 1 is initiated wherein the material 4 is further formed according to the arrangement/pattern of the cutting wire 3. The plates of the floor covering system may thereafter be cut in their desired shapes and sizes.

According to another embodiment, the pivot axis p extends at any position along the connection portion 2c or anywhere along the extension of the connection portion 2c. According to one embodiment, the pivot axis p extends at a center point of the connection portion 2c. Thus, even plate 1 may be formed/cut by such cutting device 1, since the important aspect here is to point the extension of the connection portion 2c towards a thought center point, i.e. a drainage point. To be able to carry out this a translation of the cutting device 1 may need to be carried out parallel to the rotation of the cutting device 1.

FIGS. 9a and 9b shows an arrangement for cutting material using a cutting device according to the second embodiment of the invention which for example may be arranged at a production site. Here the material 4 is rotating around an imaginary pivot axis p through the point P along the first axis x of the cutting device 2 and the cutting device 2 is locked in in relation to the ground. The material 4 is in one embodiment arranged on and attached to a transporting device 4a. The transporting device 4a may be arranged to rotate around an axis essentially parallel to the imaginary pivot axis p but locally associated with the transporting device 4a. A driving device may be arranged to move said the material and the transporting device 4a in a direction essentially perpendicular to and/or essentially parallel to the extension direction of the pivot axis p. The driving device may also be used to move the material 4 in any direction in space.

Preferred embodiments of a cutting device 1 according to the invention has been described. However, the person skilled in the art realizes that this can be varied within the scope of the appended claims without departing from the inventive idea.

All the described alternative embodiments above or parts of an embodiment can be freely combined without departing from the inventive idea as long as the combination is not contradictory.

1-28. (canceled)

29. A cutting device for cutting a material into plates for a surface covering system, comprising:
a frame structure comprising at least two essentially parallelly arranged frame portions arranged at a distance (d) from each other along a first axis (x),
a cutting wire extending between the frame portions and connected to the respective frame portions
wherein the cutting device comprises means for creating a pivoting relative movement between the frame structure and a material,
wherein the material is cut and formed by the cutting wire during a pivoting relative movement between the frame structure and the material around a pivot axis (p),
wherein the pivot axis (p) is running through a pivot point (P) arranged at any point along said first axis (x),
wherein the cutting wire extends between the frame portions with an angle α to a direction parallel to the first axis (x) of the frame structure.

30. The cutting device according to claim 29, wherein the pivot axis (p) is perpendicular to the first axis (x).

31. The cutting device according to claim 29, wherein the first axis (x) coincide with the x-axis of a coordinate system comprising axis x, y, z defined in relation to the cutting device, wherein the z-axis of the coordinate system extends through a point located between the first and second frame portions, at a distance d/2 from the first frame portion, wherein the pivot axis (p) is parallel to the z-axis.

32. The cutting device according to claim 31, wherein the frame portions are parallel to the z-axis.

33. The cutting device according to claim 29, wherein said pivot axis (p) is running through a pivot point (P) arranged at any point along said first axis (x) arranged at a distance (r, R) from a point associated with the material or frame structure.

34. The cutting device according to claim 29, wherein said frame structure is arranged to be pivoted around the pivot axis (p).

35. The cutting device according to claim 34, wherein the pivot axis (p) is arranged to extend through one of the frame portions.

36. The cutting device according to claim 34, wherein said frame structure is arranged to be moved in all directions in space.

37. The cutting device according to claim 29, wherein said material is arranged to be pivoted around a pivot axis (p).

38. The cutting device according to claim 37, wherein said frame structure is arranged to be locked in all directions in space.

39. The cutting device according to claim 37, wherein said material is arranged to be moved in all directions in space.

40. The cutting device according to claim 37, wherein said material is arranged on and attached to a transporting device.

41. The cutting device according to claim 29, wherein said material is arranged to be locked in all directions in space.

42. The cutting device according to claim 29, wherein the cutting wire extends at least two times between the frame portions.

43. The cutting device according to claim 29, wherein the cutting wire comprises at least two cutting wires extending between the frame portions.

44. The cutting device according to claim 42, wherein the cutting wire or cutting wires extend between the frame portions according to a recurrent pattern, comprising a first extension portion between the frame portions which is perpendicular to the pivot axis and a second extension portion which extends between the frame portions with an angle α to a direction perpendicular to the pivot axis (p) of the frame structure.

45. The cutting device according to claim 29, wherein the cutting wire is one of: an electric heating wire, a rotating wire or a reciprocating wire.

46. The cutting device according to claim 29, wherein at least one driving device is arranged to pivot the frame structure in relation to the material.

47. The cutting device according to claim 29, wherein at least one driving device is arranged to pivot the material in relation to the frame structure.

48. The cutting device according to claim 29, wherein at least one driving device is arranged to move said frame structure and/or said material in a direction essentially perpendicular and/or essentially parallel to the extension direction of the pivot axis (p).

49. The cutting device according to claim 29, wherein at least one driving device is arranged to move said frame structure and/or said material in any direction in space.

50. The cutting device according to claim 29, wherein the distance d between the frame portions is in the range of 50 mm to 3000 mm, preferably 2000 mm.

51. The cutting device according to claim 29, wherein the angle α is in the range of 0, 1-5°, preferably in the range 0, 1-3°.

52. The cutting device according to claim 29, wherein the cutting wire extends essentially in a straight line between the frame portions.

53. The cutting device according to claim 29, wherein the cutting wire or cutting wires is/are connected to the frame portions at connection points wherein the connection points are adjustable along the frame portions to control the angle α.

54. The cutting device, according to claim 29, wherein the cutting device is arranged to cut and form material in plate form, wherein a plurality of similarly and differently formed plates together form a surface covering system.

55. A cutting device according to claim 29, wherein said means for creating a pivoting relative movement is a driving device arranged to pivot the frame structure in relation to the material.

56. A cutting device according to claim 29, wherein said means for creating a pivoting relative movement is a driving device arranged to pivot the material in relation to the frame structure.
